(19) United States
(12) Patent Application Publication
(10) Pub. No.: US 2021/0404247 A1
(43) Pub. Date: Dec. 30, 2021

(54) SECURITY PET DOOR ASSEMBLY

(71) Applicants: Allen Schwartz, Strawberry, AZ (US); Ian Walston, Strawberry, AZ (US)

(72) Inventors: Allen Schwartz, Strawberry, AZ (US); Ian Walston, Strawberry, AZ (US)

(21) Appl. No.: 17/360,776

(22) Filed: Jun. 28, 2021

Related U.S. Application Data
(60) Provisional application No. 63/045,666, filed on Jun. 29, 2020.

(51) Int. Cl. E06B 7/32; E05C 19/08

(52) U.S. Cl. CPC E06B 7/32; E05C 19/08

(57) ABSTRACT

The disclosed pet door assembly according to various aspects of the present technology may comprise a frame adapted to be installed circumjacent to an opening of a building and a plurality of coupling components configured to connect the frame to the building. The pet door assembly may also comprise a door panel connected to the frame by at least one hinge. The door panel may be configured to move, relative to the frame, between an open position and a closed position, wherein the plurality of coupling components and the at least one hinge are at least partially concealed from the exterior of the building when the door panel is in the closed position.

### CROSS-REFERENCE TO RELATED APPLICATION

This application claims the benefit of U.S. Provisional Patent Application Ser. No. 63/045,666, filed on Jun. 29, 2020, and incorporates the disclosure of the application in its entirety by reference.

### BACKGROUND OF THE TECHNOLOGY

A pet door assembly allows a pet, such as a dog or cat, to enter and exit a building by passing through an opening of the building. A conventional pet door assembly typically comprises a frame adapted to be fitted into the opening of a wall or door and a hinged and/or spring-loaded panel or flexible flap that may be pushed open by the pet and that returns automatically to a closed position.

A conventional pet door assembly is typically large enough to permit a variety of differently sized pets to pass through the opening. In addition, a conventional pet door assembly is typically made of materials that are easily broken or made in a configuration that is easily breached. Accordingly, a conventional pet door assembly may not prevent unwanted animals and people, e.g., intruders, from passing through the opening, even if the pet door assembly is locked.

Existing systems and methods have attempted various solutions by, for example, using electronically controlled locking mechanisms to lock the pet door, but they have not sufficiently addressed the need of the pet door industry owing to their ineffectiveness, overly technical nature, and need for costly additional computer hardware and software. Thus, the conventional systems and methods, if implemented, have not been successful in preventing unwanted animals and people, i.e., intruders, from passing through the opening in the building.

### SUMMARY OF THE TECHNOLOGY

The disclosed pet door assembly according to various aspects of the present technology may comprise a frame adapted to be installed circumjacent to an opening of a building and a plurality of coupling components configured to connect the frame to the building. The pet door assembly may also comprise a door panel connected to the frame by at least one hinge. The door panel may be configured to move, relative to the frame, between an open position and a closed position, wherein the plurality of coupling components and the at least one hinge are at least partially concealed from the exterior of the building when the door panel is in the closed position.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a perspective view of a pet door assembly, with a door panel in an open position, in accordance with an embodiment of the present technology;

FIG. 2 representatively illustrates a perspective view of the pet door assembly illustrated in FIG. 1 with the door panel in a closed position;

FIG. 3 representatively illustrates a perspective view of a pet door assembly with a variation in door panel design in accordance with an embodiment of the present technology;

FIG. 4 representatively illustrates a perspective view of a pet door assembly with a variation in door panel design in accordance with an embodiment of the present technology;

FIG. 5 representatively illustrates a perspective view of a pet door assembly with a variation in door panel design in accordance with an embodiment of the present technology;

FIG. 6 representatively illustrates a perspective view of a pet door assembly with a variation in door panel design in accordance with an embodiment of the present technology;

FIG. 7 representatively illustrates a front view of the pet door assembly installed circumjacent to an opening of a building as viewed from an interior of the building; and

FIG. 8 representatively illustrates a rear view of the pet door assembly illustrated in FIG. 7 as viewed from an exterior of the building.

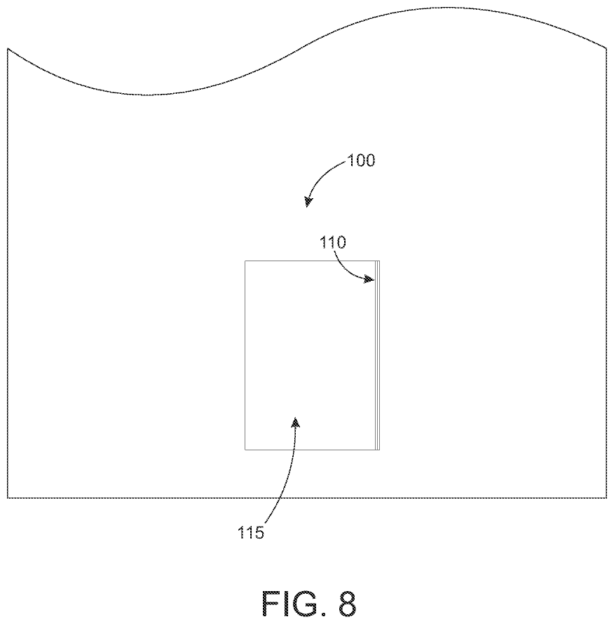

### DETAILED DESCRIPTION OF EXEMPLARY EMBODIMENTS

The present technology may be described herein in terms of functional block components. Such functional blocks may be realized by any number of components configured to perform the specified functions and achieve the various results. For example, the present technology may employ various coupling components, door panels, frames, hinges, knuckles, locking components, pins, and the like, which may carry out a variety of functions. In addition, the present technology may be practiced in conjunction with any number of pet door assemblies and any one of various openings in a building, and the pet door assembly described herein is merely one exemplary application for the technology.

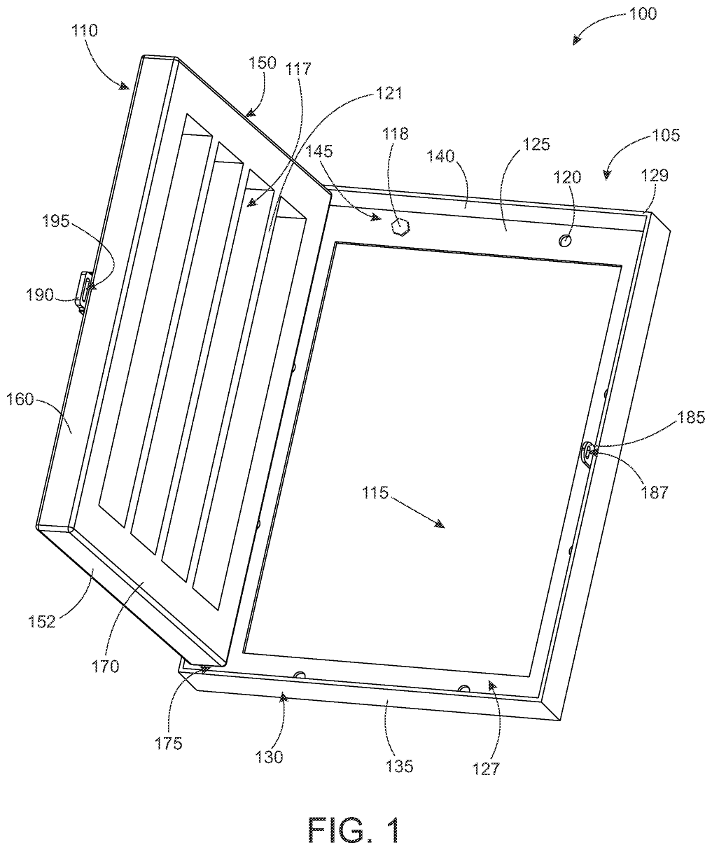

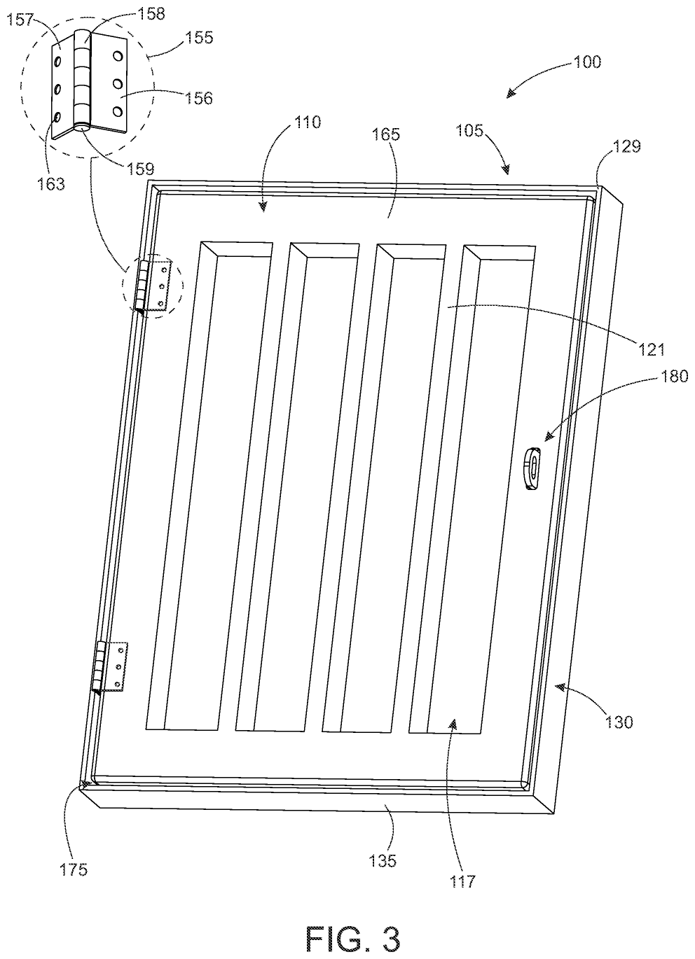

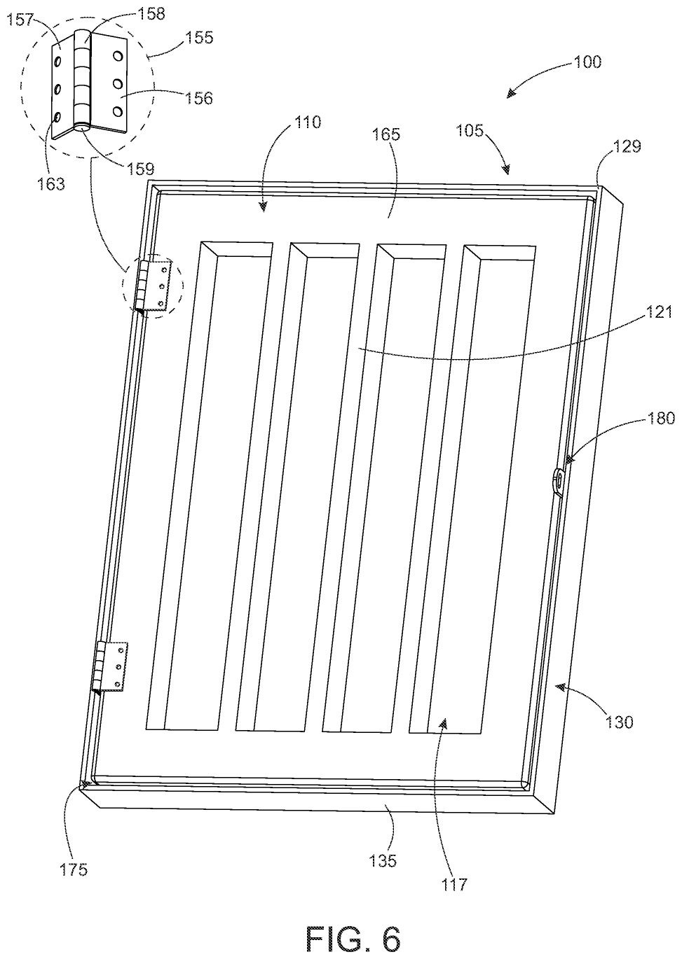

Referring to FIGS. 1-7, in various embodiments, a pet door assembly 100 may comprise a frame 105 and a door panel 110. The frame 105 may be adapted to be installed circumjacent to an opening 115 of a building to allow an owner's pet, such as a cat or dog, to pass through the opening 115. The pet door assembly 100 may also comprise a plurality of coupling components 118 configured to fixedly connect the frame 105 to the building.

The frame 105 may comprise a proximal base 125 having an outer perimeter and an inner perimeter defining the opening 115. The proximal base 125 may be positioned adjacent to the building and the opening 115 may be of any suitable size or shape so as to allow a pet, such as a dog or cat, to pass through the opening 115 when the frame 105 is fixedly connected to the building. The frame 105 may further comprise an open distal end 127 opposite the proximal base 125, where the open distal end 127 may terminate in a peripheral edge 129. The frame 105 may further comprise a sidewall 130 disposed around the outer perimeter and extending from the proximal base 125 to the peripheral edge 129. The sidewall 130 may comprise an outer surface 135 and an inner surface 140 defining a receptacle cavity 145. In some embodiments, the frame 105 may be constructed from any suitable number of angle bars, where each angle bar may comprise two “legs” that are perpendicular to each other.

The frame 105 may also comprise a plurality of apertures 120 for receiving the coupling components 118 therethrough. Specifically, each aperture 120 may receive a respective one of the plurality of coupling components 118 therethrough for coupling the frame 105 to the building. The plurality of coupling components 118 may comprise any suitable mechanical connectors, such as rivets, screws, bolts, or any other combination thereof. As an example, in the case where the coupling components 118 are screws, the frame 105 may be coupled to the building by twisting each coupling component 118 into a locked position by pressing the coupling component 118 towards the building and through its respective aperture 120 and then turning the coupling component 118 to lock into position. Conversely, the frame 105 may be decoupled from the building by twisting each coupling component 118 into an unlocked position and then disengaging the coupling component 118 from the building.

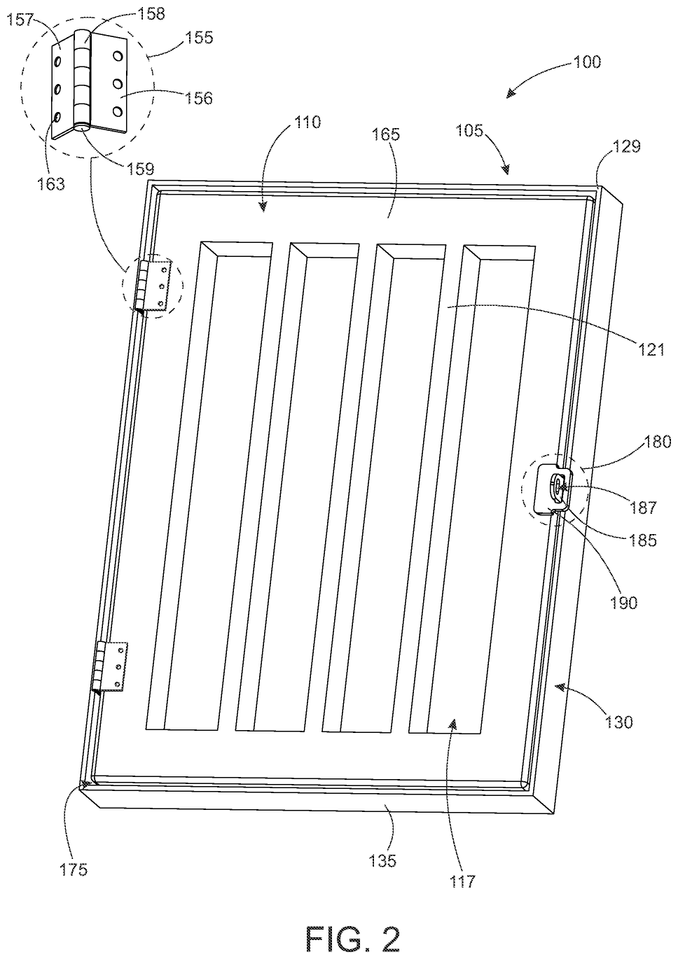

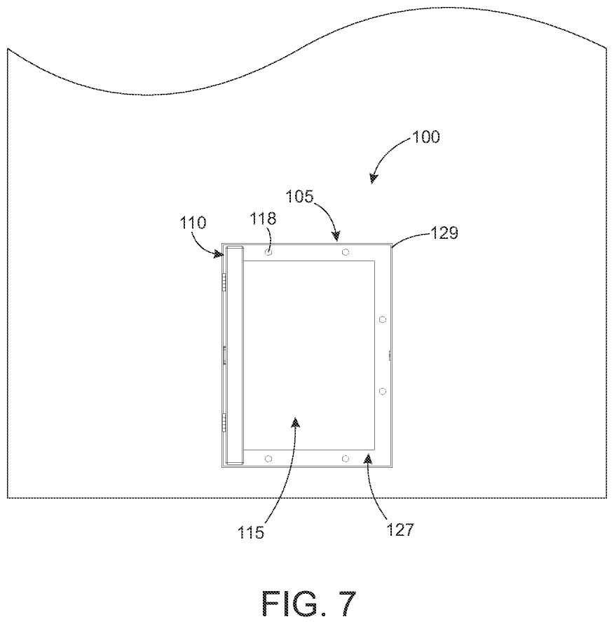

In various embodiments, the door panel 110 may be connected to the frame 105 by at least one hinge 155, such that the door panel 110 may be swung, relative to the frame 105, between an open position, as shown in FIGS. 1 and 7, and a closed position, as shown in FIGS. 2-6. The door panel 110 may comprise any suitable size or shape such as a rectangular-shaped body or a square-shaped body so long as the door panel 110 may fit within the receptacle cavity 145 when the door panel is in the closed position. The door panel 110 may comprise a top surface 150, a bottom surface 152, and a pair of opposing side surfaces 160. The door panel 110 may also comprise an inner surface 165 to be oriented towards the interior of the building and an outer surface 170 to be oriented towards the exterior of the building.

As an example, in the case where the frame 105 comprises a rectangular-shaped body as shown in FIGS. 1-7, the door panel 110 may comprise a rectangular-shaped body, where the height of the door panel 110 may be less than the height of the frame 105 and the width of the door panel 110 may be less than the width of the frame 105. In this regard, the door panel 110 and the inner surface 140 of the sidewall 130 may define a gap 175 therebetween when the door panel 110 is disposed within the receptacle cavity 145.

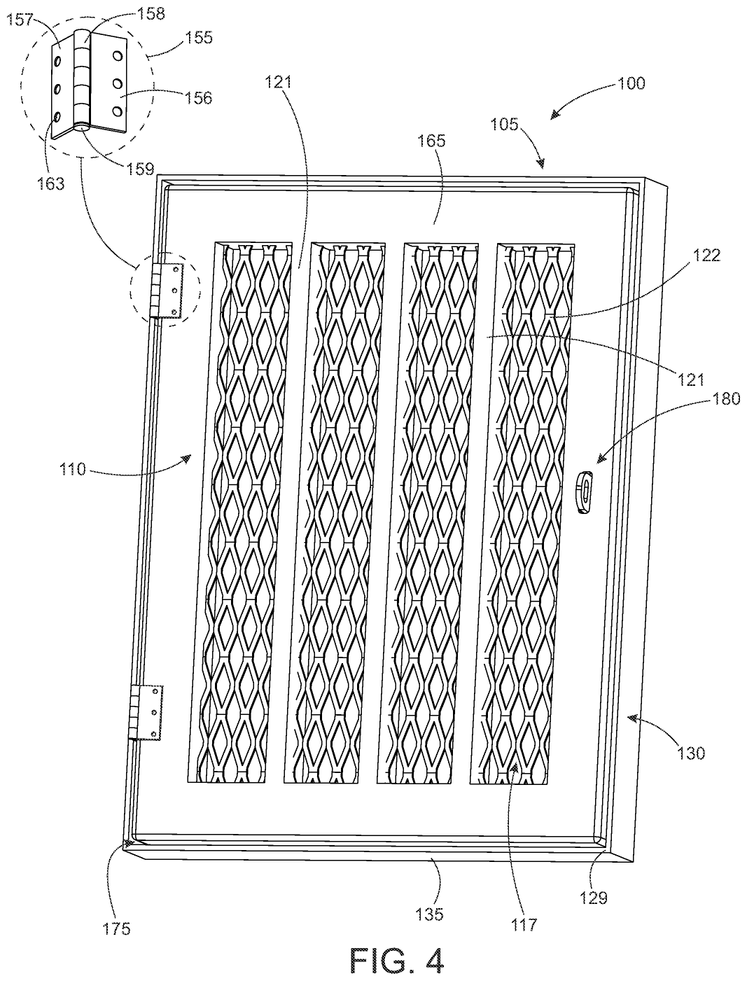

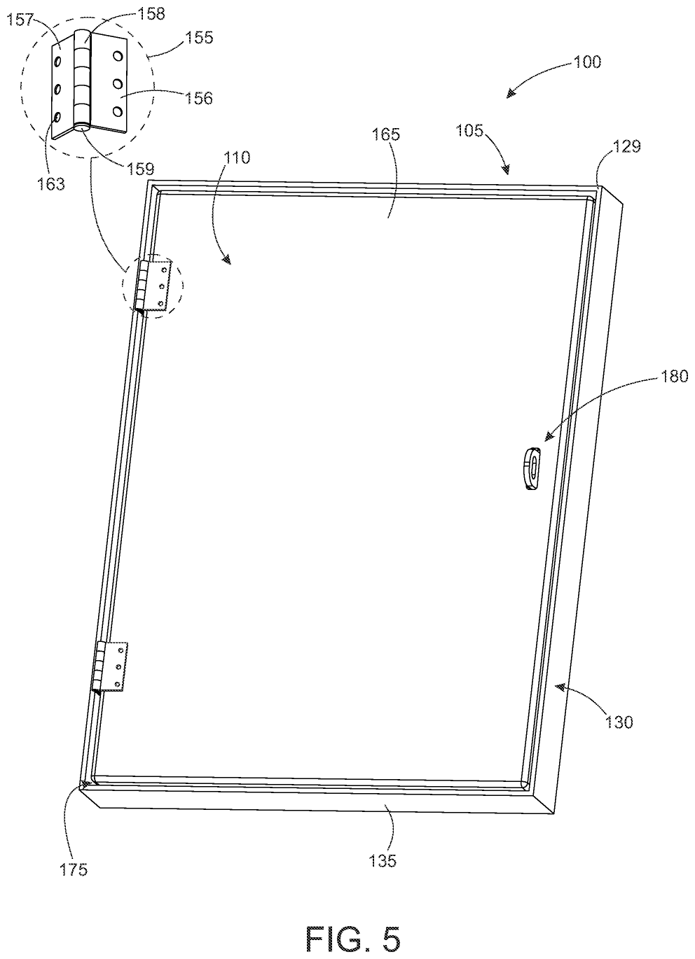

It will be appreciated that modifications may be made to the door panel 110 without departing from the scope of the invention. For example, in some embodiments, the door panel 110 may comprise a solid door panel, as shown in FIG. 5. In other embodiments, as shown in FIGS. 1-4 and 6, the door panel 110 may comprise an aperture 117 therethrough and one or more equidistantly spaced vertical bars 121 disposed within the aperture 117. In other embodiments, the door panel 110 may comprise one or more equidistantly spaced horizontal bars (not shown) disposed within the aperture 117. As shown in FIG. 4, in some embodiments, the door panel 110 may comprise a mesh sheet 122, such as an expanded metal or other robust screen material, disposed within the aperture 117 and between the vertical bars 121.

The at least one hinge 155 may comprise a first plate 156, a second plate 157, a pair of interdigitating knuckles 158, and a pin 159. The at least one hinge 155 may connect the outer surface 165 of the door panel 110 to the inner surface 140 of the sidewall 130 in any suitable manner. For example, the first plate 156 may be fixedly connected to the outer surface 165 of the door panel 110 and the second plate 157 may be fixedly connected to the inner surface 140 of the sidewall 130.

In some embodiments, each plate 156, 157 of hinge 155 may comprise a plurality of apertures 163 for receiving one or more suitable mechanical connectors therethrough. Accordingly, the first and second plates 156, 157 may be fixedly connected to the outer surface 165 of the door panel 110 and the inner surface 140 of the sidewall 130, respectively, by any suitable mechanical connectors, such as rivets, screws, bolts and/or any combination thereof. In other embodiments, the first and second plates 156, 157 may be fixedly connected to the outer surface 165 of the door panel 110 and the inner surface 140 of the sidewall 130, respectively, by welding each plate 156, 157 to its respective surface. The at least one hinge 155 may comprise any suitable hinge, such as a piano hinge, a door hinge, and the like, for connecting the door panel 110 to the frame 105.

As shown in FIGS. 1-7, in an exemplary embodiment, the plurality of coupling components 118 and the at least one hinge 155 may be at least partially concealed from the exterior of the building when the door panel 110 is in the closed position. For example, the first plate 156 may be connected to the inner surface 165 of the door panel 110 and the second plate 157 may be disposed within the gap 175. Accordingly, the first and second plates 156, 157 may each be concealed from the exterior of the building and are thus inaccessible to an unwanted person, such as intruder, when the door panel 110 is in the closed position. In addition, the at least one hinge 155 may be configured in any suitable manner such that it may be resistant to breaking or breaching by an unwanted animal or person. For example, the pair of interdigitating knuckles 158 may be comprised of a material selected from steel, iron, or a combination thereof. In addition, each pin 159 may comprise an irremovable pin.

The pet door assembly 100 may further comprise a locking component 180. In an exemplary embodiment, the locking component 180 may be concealed and inaccessible from the exterior of the building when the door panel 110 is in the closed position. The locking component 180 may comprise any suitable device or system for locking the door panel 110 to the frame 105. The locking component 180 may be configured to constrain a movement of the door panel 110 with respect to the frame 105. In addition, the locking component 180 may also be configured to disengage the door panel 110 from the frame 105.

In one embodiment, and referring now to FIGS. 1-6, the pet door assembly 100 may comprise a hasp 185 with an aperture 187 coupled to the inner surface 140 of the sidewall 130 at a location opposite the location of the at least one hinge 155. The hasp 185 may extend outwards from the gap 175 and through a receiving member 190 with an aperture 195, where the receiving member 190 may be attached to the door panel 110. When the door panel 110 is in the closed position, a lock (not shown) may be inserted through the aperture 187 and then locked to constrain a movement of the door panel 110 with respect to the frame 105. After use, the lock (not shown) may be unlocked and then removed from the aperture 187 to allow the door panel 110 to be withdrawn or otherwise detached from the frame 105. For example, once the lock (not shown) is removed from the aperture 187, the door panel 110 may be swung, relative to the frame 105, into the open position, as shown in FIGS. 1 and 7.

In an alternative embodiment, the locking component 180 may be pivotal between a locked position wherein a movement of the door panel 110 with respect to the frame 105 may be constrained, and an unlocked position wherein the door panel 110 may be disengaged from the frame 105. For example, the locking component 180 may comprise a deadbolt (not shown) or latch (not shown) coupled to the door panel 110 and configured to lock the door panel 110 to the frame 105.

In some embodiments, the various components of the pet door assembly 100 may be constructed from a variety of suitable metal materials, such as steel, iron, copper, titanium, zinc, magnesium, aluminum, or any other combination of metal materials. In other embodiments, the components of the pet door assembly 100 may be constructed from a variety of suitable composite materials, such as aluminum, nylon, plexiglass, fiberglass, or any other combination of metal and composite materials.

It will be appreciated that, in some embodiments, the present disclosure may further provide a kit-of-parts for a pet door assembly as described herein, where the kit-of-parts may comprise at least one coupling component as described herein, at least one door panel as described herein, at least one frame as described herein, at least one hinge as described herein, and at least one locking component as described herein. The kit-of-parts may comprise separate components adapted to be assembled by the end consumer. In some cases, the kit-of-parts may reduce waste material, thereby increasing cost-efficiency and reducing the time necessary to manufacture the components of the pet door assembly. It will also be appreciated that, in other embodiments, any or all the components may be manufactured simultaneously and integrally joined with one another by the manufacturer.

Manufacturing the various components of the pet door assembly 100 may comprise performing any or all of the following: extrusion, pultrusion, vacuum formation, injection molding, blow molding, casting, forging, cold rolling, milling, drilling, reaming, turning, grinding, stamping, cutting, bending, welding, soldering, hardening, riveting, punching, plating, and the like.

In the case where the components of the pet door assembly described herein are manufactured separately, manufacturing the pet door assembly 100 may comprise coupling the various components in any suitable manner, such as with adhesive, a weld, a fastener, e.g. a bolt, a nut, a screw, a nail, a rivet, a pin, and the like, wiring, sewing, or any combination thereof depending on, among other considerations, the particular material forming the components. Manufacturing the pet door assembly described herein may further comprise performing any or all of the following: sand blasting, polishing, powder coating, zinc plating, anodizing, hard anodizing, and/or painting the components.

In operation, once installed, a pet owner may move the door panel 110, relative to the frame 105, between an open position, as shown in FIGS. 1 and 7, and a closed position, as shown in FIGS. 2-6. When the door panel 110 is in the open position, a pet may pass through the opening 115. The pet owner may move the door panel 100, relative to the frame 105, in a closed position when the pet owner does not want his or her pet to pass through the opening 115, such as at night or in the case of inclement weather. Because the pet door assembly 100 may comprise a locking component 180, once the door panel 110 is in the closed position, the pet owner may use the locking component 180 to constrain a movement of the door panel 110 with respect to the frame 105. Because the pet door assembly 100 may be made of a material selected from steel, iron, or a combination thereof, and the at least one hinge 155 and the plurality of coupling components 118 may be concealed and inaccessible from the exterior of the building, the likelihood that an unwanted animal or person may break the pet door assembly 100 is reduced.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the technology should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims. Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A pet door assembly, comprising:
a frame adapted to be installed circumjacent to an opening of a building;
a plurality of coupling components configured to connect the frame to the building;
a door panel connected to the frame by at least one hinge and configured to move, relative to the frame, between an open position and a closed position, wherein the plurality of coupling components and the at least one hinge are at least partially concealed from the exterior of the building when the door panel is in the closed position.

2. The pet door assembly of claim 1, wherein the frame comprises:
a proximal base positioned adjacent to the building, wherein the proximal base comprises:
an inner perimeter defining an opening in the frame; and
an outer perimeter; and
an open distal end opposite the proximal base terminating in a peripheral edge; and
a sidewall disposed around the outer perimeter and extending from the proximal base to the peripheral edge, wherein the sidewall comprises an outer surface and an inner surface defining a receptacle cavity.

3. The pet door assembly of claim 2, wherein:
the door panel comprises:
a top surface, a bottom surface, and two opposing side surfaces;
an inner surface to be oriented towards the interior of the building; and
an outer surface to be oriented towards the exterior of the building; and
the door panel and the inner surface of the sidewall define a gap therebetween when the door panel is disposed within the receptacle cavity.

4. The pet door assembly of claim 3, wherein the hinge is at least partially disposed within the gap.

5. The pet door assembly of claim 3, wherein the at least one hinge comprises:
a first plate connected to the outer surface of the door panel;
a second plate connected to the inner surface of the sidewall;
a pair of interdigitating knuckles; and
a pin.

6. The pet door assembly of claim 5, wherein the pin comprises an irremovable pin.

7. The pet door assembly of claim 1, wherein the door panel comprises at least one of a solid door panel or a mesh door panel.

8. The pet door assembly of claim 1, wherein the plurality of coupling components comprises at least one of a mechanical fastener or an interlocking fastener.

9. The pet door assembly of claim 1, further comprising a locking component configured to constrain a movement of the door panel with respect to the frame.

10. The pet door assembly of claim 9, wherein the locking component is further configured to disengage the door panel from the frame.

11. The pet door assembly of claim 9, wherein the locking component is at least partially concealed from the exterior of the building when the door panel is in the closed position.

12. The pet door assembly of claim 9, wherein the frame, door panel, at least one hinge, and locking component are comprised of a material selected from steel, iron, or a combination thereof.
